(19) United States
(12) Patent Application Publication
(10) Pub. No.: US 2012/0134463 A1
(43) Pub. Date: May 31, 2012

(54) RADIATION TUBE AND RADIATION IMAGING SYSTEM

(75) Inventor: Yasuhisa KANEKO, Ashigarakami-gun (JP)

(73) Assignee: FUJIFILM CORPORATION, Tokyo (JP)

(21) Appl. No.: 13/304,025

(22) Filed: Nov. 23, 2011

(30) Foreign Application Priority Data
Nov. 26, 2010 (JP) 2010-263814

(51) Int. Cl. G01N 23/02; H01J 35/06

(52) U.S. Cl. 378/19; 378/122

(57) ABSTRACT

An X-ray tube has a cathode, a rotating anode, and a case for enclosing the cathode and the rotating anode. The rotating anode generates X-rays due to emission of electron beams from the cathode. The case includes a vacuum envelope for enclosing the cathode and the rotating anode, and a housing for enclosing the vacuum envelope. Inside of the vacuum envelope is maintained vacuum. The vacuum envelope has an X-ray passing portion for passing the X-rays therethrough. The housing is provided with a radiation window for radiating the X-rays, passed through the X-ray passing portion, to the outside of the case. The radiation window includes an opening and a multi-slit arranged in the opening. The multi-slit partly shields the X-rays, generated by the rotating anode, to form a plurality of virtual linear light sources.

### BACKGROUND OF THE INVENTION

1. Field of the invention

The present invention relates to a radiation tube for use in phase contrast imaging and a radiation imaging system using a radiation tube.

2. Description Related to the Prior Art

When incident on an object, radiation (for example, X-rays) changes its intensity and phase due to interaction with the object. It is known that the phase change interacts more strongly than the intensity change with the object. X-ray phase imaging takes advantage of this property. Using the X-ray phase imaging technique, a high contrast image (hereinafter referred to as the phase contrast image) of an object with low X-ray absorption is captured based on the phase change (angular change) of the X-rays caused by the object. Researches on the X-ray phase imaging have been conducted actively.

An X-ray imaging system using a Talbot-Lau interferometer is known as an X-ray phase imaging apparatus (see, U.S. Patent Application Publication No. 2009/0092227 corresponding to Japanese Translation of PCT International Publication No. 2008-0545981, for example). In the X-ray imaging system, a multi-slit arranged outside of an X-ray tube partly shields X-rays emitted from the X-ray tube. This forms a plurality of virtual linear X-ray sources arranged at a predetermined pitch. Each of the virtual linear X-ray sources has a narrow width. The X-ray tube has an X-ray focal point of a common size (for example, of the order of 0.1 mm to 1 mm). On the other hand, a focal point of each virtual X-ray source is smaller than that of the X-ray tube. As a result, optimum spatial coherence for the X-ray phase imaging is obtained. Additionally, the multi-slit makes a single X-ray source into a plurality of the X-ray sources, which enhance X-ray intensity.

In the X-ray imaging system, a first grid (or grating) is arranged to face the multi-slit. A second grid (or grating) is arranged downstream from the first grating by a Talbot length. An X-ray image detector (a flat panel detector, hereinafter abbreviated as the FPD) is arranged behind the second grating. The FPD detects the X-rays to generate an image. An object is arranged between the multi-slit and the first grating. Using the first and second gratings, a fringe image is generated from the X-rays passed through the object. Changes in the fringe image are detected using a fringe scanning method, to obtain phase information of the object (for example, see the U.S. Patent Application Publication No. 2009/0092227, and “Differential x-ray phase contrast imaging using a shearing interferometer” C. David et al., Applied Physics Letters, page 3287, Vol. 81, No. 17, October 2002).

In the fringe scanning method, an image is captured every time the second grating is moved translationally relative to the first grating. The second grating is moved substantially parallel to a surface of the first grating and in a direction substantially vertical to a grating direction of the first grating at a scan pitch which is one of equally-divided parts of a grating pitch. Angular distribution (a differential image of the phase shift) of the X-rays refracted by the object is obtained from changes in each of pixel values detected by the X-ray image detector. Based on the angular distribution, a phase contrast image of the object is obtained. The fringe scanning method is also applied to an imaging apparatus using laser light (for example, see “Improved phase-shifting method for automatic processing of moiré deflectograms”, Hector Canabal et al., Applied Optics, page 6227, Vol. 37, No. 26, September 1998).

In the X-ray imaging system using the Talbot-Lau interferometer, the multi-slit is arranged outside of the X-ray tube. So, the multi-slit is distant from the X-ray focal point where the X-rays are generated in the X-ray tube. As a result, the X-rays are likely to include a noncoherent component. Additionally, the X-rays are more likely to include a scatter component as the distance between the X-ray focal point and the multi-slit increases.

Conventionally, an X-ray tube using an absorption grating to adjust the size of its X-ray focal point has been known (for example, see U.S. Patent Application Publication No. 2007/0189449 corresponding to Japanese Patent Laid-Open Publication No. 2007-0206076). The absorption grating, having the effect similar to that of the multi-slit, is arranged behind the X-ray focal point in an X-ray beam path. In this configuration, the absorption grating is arranged inside the X-ray tube. As a result, a distance between the X-ray focal point and the absorption grating is shortened.

The X-ray tube of the U.S. Patent Application Publication No. 2007/0189449 needs a large-sized vacuum envelope to enclose the absorption grating therein in addition to the cathode and the anode. Accordingly, cost and size of the X-ray tube increase. In the vacuum envelope, the anode is heated by the impinging electron beams emitted from the cathode. Being positioned close to the cathode and the anode, the absorption grating is likely to be influenced by heat from the anode. When the temperature of the absorption grating increases, a grating pitch may vary or even the absorption grating may be curved or deformed due to the difference between thermal expansion coefficients of the materials constituting the absorption grating. Thus, the temperature rise results in deterioration of grating performance and poor durability. Note that the U.S. Patent Application Publication No. 2007/0189449 does not touch upon heat dissipation from the absorption grating.

### SUMMARY OF THE INVENTION

An object of the present invention is to provide a radiation tube capable of arranging a multi-slit in a position closest to an X-ray focal point without affecting the cost and the size of the radiation tube, and a radiation imaging system using a radiation tube.

To achieve the above and other objects, a radiation tube of the present invention includes a cathode, an anode, a case, and a multi-slit. The cathode emits electron beams. The anode generates radiation due to emission of the electron beams from the cathode. The case encloses the cathode and the anode. The case includes a radiating portion for radiating the radiation to outside of the case. The multi-slit is provided to the radiating portion. The multi-slit partly shields the radiation to form a plurality of linear light sources.

When the case has a vacuum envelope for enclosing the cathode and the anode, and a housing for enclosing the vacuum envelope, it is preferable that the radiating portion includes an opening formed through the housing. The multi-slit may be provided to the opening. The multi-slit may be fixed to the housing so as to cover the opening. The multi-slit may include a radiation-transmitting member filled in the opening and a multi-slit pattern provided to the radiation-transmitting member.

When the case has a vacuum envelope for enclosing the cathode and the anode, and a housing for enclosing the vacuum envelope, it is preferable that the radiating portion includes a radiation passing portion provided to the vacuum envelope. The radiation passing portion allows the radiation to pass therethrough. The multi-slit pattern may be provided to the radiation passing portion.

A radiation imaging system of the present invention includes a first grating, an intensity modulator, a radiation image detector, and a processor. The first grating passes radiation from a radiation source to forma first periodic pattern image. The first grating has transmission portions for transmitting the radiation and absorption portions for absorbing the radiation. The transmission portions and the absorption portions are arranged periodically to form a grating structure. The intensity modulator provides intensity modulation to the first periodic pattern image in at least one of relative positions out of phase with the first periodic pattern image. The radiation image detector detects a second periodic pattern image. The second periodic pattern image is generated in the relative position by the intensity modulator. The processor produces an image representing phase information based on the at least one second periodic pattern image detected by the radiation image detector. A radiation tube is used as the radiation source.

The intensity modulator may include a second grating and a scan section. The second grating has transmission portions for transmitting the first periodic pattern image and absorption portions for absorbing the first periodic pattern image. The transmission portions and the absorption portions are arranged periodically to forma grating structure. The scan section moves one of the first and second gratings to positions at a predetermined pitch in a direction of periodicity of the grating structures of the first and second gratings. The positions, to which the first or second grating is moved by the scan section, may correspond to the respective relative positions.

According to the present invention, the multi-slit is provided to the radiating portion. Accordingly, a distance between the focal point of the radiation and the multi-slit is shortened compared with a conventional imaging system in which the multi-slit is arranged outside of the radiation source. Thereby, a noncoherent component and a scatter component of the radiation are reduced. As a result, the image quality of the phase contrast image is improved. Because the multi-slit is not enclosed in the vacuum envelope, the cost and the size of the radiation tube do not increase from those of the conventional radiation tube. Moreover, because the multi-slit is in contact with the housing or the vacuum envelope, the multi-slit is excellent in heat dissipation. As a result, the multi-slit of the present invention is less affected by heat.

A multi-slit pattern is provided to the X-ray transmitting member of the radiation window just by making a change to a conventional radiation tube and it is relatively easy. The distance between the focal point of the radiation and the multi-slit pattern is further shortened when the multi-slit is provided to the vacuum envelope. According to the radiation imaging system of the present invention, the image quality of the phase contrast image is improved with the use of the radiation tube of the present invention.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a schematic view showing a configuration of an X-ray imaging system of the present invention;

FIG. 2A is a schematic view showing a configuration of an X-ray tube of a first embodiment of the present invention;

FIG. 2B is a schematic view showing a multi-slit;

FIG. 3 is an explanatory view showing a relationship among a pitch between linear light sources, a pitch of a first absorption grating and a pitch of a second absorption grating;

FIG. 4 is a schematic view showing a configuration of an X-ray tube of a second embodiment; and

FIG. 5 is a schematic view showing an X-ray tube of a third embodiment.

### DESCRIPTION OF THE PREFERRED EMBODIMENTS

### First Embodiment

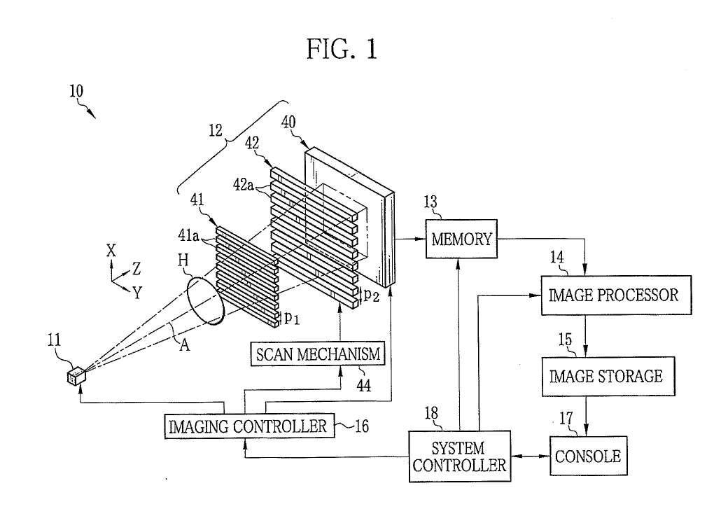

As shown in FIG. 1, a radiation imaging system, for example, an X-ray imaging system 10 of the present invention is provided with an X-ray source 11 and an imaging unit 12. The X-ray source 11 applies X-rays to an object H. The imaging unit 12 is arranged to face the X-ray source 11. The imaging unit 12 detects the X-rays, applied from the X-ray source 11 and then passed through the object H, to generate image data. The imaging unit 12 is connected to a memory 13. The memory 13 stores the image data read out from the imaging unit 12. The memory 13 is connected to an image processor 14. The image processor 14 processes multiple image data stored in the memory 13 to generate a phase contrast image, and then stores the phase contrast image in image storage 15. The X-ray source 11 and the imaging unit 12 are controlled by an imaging controller 16. A system controller 18 controls overall operation of the X-ray imaging system 10 based on an operation signal inputted from a console 17. The console 17 includes an operation section and a monitor, for example.

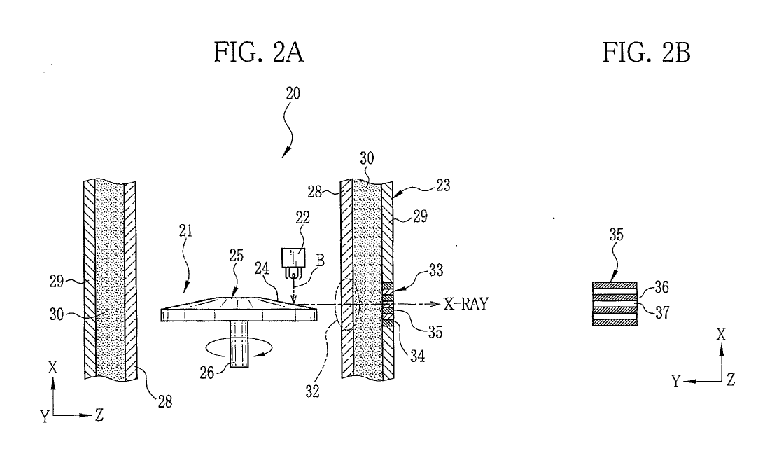

The X-ray source 11 is provided with a rotating-anode type X-ray tube 20 shown in FIG. 2A, a high voltage generator, and a collimator (both not shown). Being controlled by the imaging controller 16, the X-ray tube 20 applies the X-rays to the object H. Out of the X-rays applied from the X-ray tube 20, the collimator shields unnecessary X-rays to limit an X-ray field. Thus, the X-rays are applied only to a region of interest of the object H.

The X-ray tube 20 is provided with a rotating anode (or simply referred to as the anode) 21, a cathode 22, and a case 23. The case 23 encloses the rotating anode 21 and the cathode 22. As a matter of course, the X-ray tube 20 is also provided with a bearing section for rotatably supporting the anode 21 and a mechanism for rotating the anode 21, for example. The descriptions thereof are omitted.

The anode 21 is provided with an anode plate 25 and a rotation axis 26. The anode plate 25 is provided with an inclined surface 24 formed on an outer region of one of the surfaces of a disc. The inclined surface 24 inclines toward the other surface of the disc. The anode plate 25 has a cross-section in a shape of a circular truncated cone. The rotation axis 26 is provided at the center of the anode plate 25. The anode 21 is rotated about the rotation axis 26. The cathode 22 is arranged to face the inclined surface 24 of the anode plate 25 in an axial direction of the rotation axis 26. When a high voltage is applied from the high voltage generator, the cathode 22 emits electron beams B to the inclined surface 24. The anode plate 25 is made of molybdenum or tungsten, for example. When the electron beams B are emitted, the anode plate 25 generates X-rays with an X-ray spectrum depending on the material of the anode plate 25. The X-rays generated by the anode plate 25 are emitted in a radial direction of the rotating anode 21. Then, the X-rays are radiated to the outside of the X-ray tube 20 through a radiation window 33 of the case 23.

The case 23 includes a vacuum envelope 28, a housing 29, and insulating oil 30. Inside of the vacuum envelope 28 is maintained vacuum. The vacuum envelope 28 is enclosed by the housing 29. A space between the vacuum envelope 28 and the housing 29 is filled with the insulating oil 30. The vacuum envelope 28 is composed of a vacuum glass tube, for example, and has X-ray transmission property. The housing 29 is made of metal having X-ray shielding property, for example. The insulating oil 30 is used for cooling the vacuum envelope 28 heated by the X-ray emission.

The case 23 is provided with an X-ray passing portion 32 and the radiation window 33. The X-ray passing portion 32 is provided through the vacuum envelope 28. The X-ray passing portion 32 allows the X-rays to pass therethrough. The radiation window 33 is provided through the housing 29 to radiate the X-rays, passed through the X-ray passing portion 32, to the outside of the housing 29. The X-ray passing portion 32 and the radiation window 33 constitute a radiating portion for radiating the X-rays, generated by the rotating anode 21, to the outside of the case 23. The X-ray passing portion 32 of the vacuum envelope 28 is positioned between an X-ray focal point on the rotating anode 21, on which the electron beams B impinge, and the radiation window 33. The radiation window 33 includes an opening 34 and a multi-slit 35. The opening 34 is formed through the housing 29. The multi-slit 35 is fixed inside the opening 34 to fill or cover the opening 34.

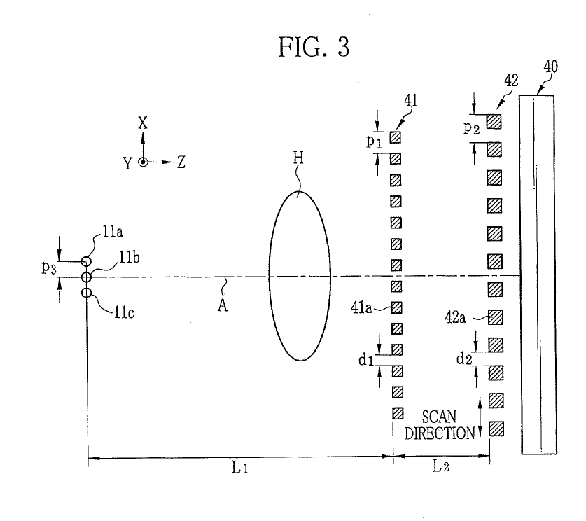

As shown in FIG. 2B, the multi-slit 35 is a one-dimensional grating. The multi-slit 35 has X-ray shielding sections 36 and X-ray transmitting sections 37. The X-ray shielding sections 36 and the X-ray transmitting sections 37 extend in Y direction and are arranged alternately in X direction orthogonal to the Y direction. The X-ray shielding sections 36 are made of metal having high X-ray shielding property, for example, gold, platinum, silver, lead, or tungsten. On the other hand, the X-ray transmitting sections 37 are made from a material having high X-ray transmission property, for example, silicon, plastic, glass, SiO₂, Al₂O₃, AlN, MgO, C, BN, Be, BeO, Ti, V, Ni, or Cu. It is preferable that the X-ray shielding sections 36 have heat resistance in addition to the X-ray shielding property. It is preferable that the X-ray transmitting sections 37 have heat resistance in addition to the X-ray transmission property. The X-ray shielding sections 36 of the multi-slit 35 partly shield the X-rays emitted from the rotating anode 21. Thereby, the effective focal size in the X direction is reduced to form virtual linear light sources (scattered light sources) 11a to 11c (see FIG. 3) arranged at a predetermined pitch in the X direction. Reduction of the X-ray focal size provides optimum spatial coherence for the phase contrast imaging. Additionally, the multiple X-ray sources increase the X-ray intensity.

As shown in FIG. 1, the imaging unit 12 is provided with a flat panel detector (FPD) 40 and first and second absorption gratings 41 and 42. The FPD 40 includes a semiconductor circuit. The first and second absorption gratings 41 and 42 are used for detecting a phase change (angular change) of the X-rays caused by the object H. The FPD 40 is arranged such that its detection surface is orthogonal to a direction (hereinafter referred to as Z direction) of an axis A of the X-rays emitted from the X-ray source 11.

The first absorption grating 41 has a plurality of X-ray shielding sections 41a extending in a direction (hereinafter referred to as the Y direction) in a plane orthogonal to the Z direction. The X-ray shielding sections 41a are arranged at a predetermined pitch p₁ in a direction (hereinafter referred to as the X direction) orthogonal to the Y and Z directions. Similarly, the second absorption grating 42 has a plurality of X-ray shielding sections 42a extending in the Y direction. The X-ray shielding sections 42a are arranged at a predetermined pitch p₂ in the X direction. It is preferable that the material of the X-ray shielding sections 41a and 42a is metal having high X-ray absorption property, for example, gold, platinum, silver, lead, or tungsten.

The imaging unit 12 is provided with a scan mechanism 44. The scan mechanism 44 moves the second absorption grating 42 translationally in a direction (X direction) orthogonal to the grating direction to vary a position of the second absorption grating 42 relative to the first absorption grating 41. The scan mechanism 44 is composed of an actuator, for example, a piezoelectric element. The scan mechanism 44 is driven and controlled by the imaging controller 16 during fringe scanning which will be described later. The image data obtained by the imaging unit 12 in each scanning step of the fringe scanning is stored in the memory 13. Note that the second absorption grating 42 and the scan mechanism 44 constitute an intensity modulator.

The image processor 14 generates a differential phase image based on the multiple image data obtained by the imaging unit 12 in the scanning steps of the fringe scanning and stored in the memory 13. The differential phase image is then integrated in the X direction to generate the phase contrast image. The phase contrast image is stored in the image storage 15, and then outputted to the console 17 to be displayed on a monitor (not shown).

An operator operates the operation section of the console 17 to input an image capture command or details of the image capture command, for example. A switch, a touch panel, a mouse, a keyboard, or the like is used as the operation section. By operating the operation section, X-ray imaging conditions such as the tube voltage of the X-ray tube and X-ray irradiation time, and imaging timing are inputted. The monitor is composed of an LCD or CRT display, for example, and displays the X-ray imaging conditions or the phase contrast image, for example.

As shown in FIG. 3, the X-ray shielding sections 41a of the first absorption grating 41 are arranged at a predetermined pitch p₁ in the X direction with a predetermined space d₁. Similarly, the X-ray shielding sections 42a of the second absorption grating 42 are arranged at a predetermined pitch p₂ in the X direction with a predetermined space d₂. The linear light sources 11a to 11c formed virtually by the X-ray tube 20 are arranged at a predetermined pitch p₃ in the X direction. The X-ray shielding sections 41a are arranged on an X-ray transmitting substrate (for example, a glass substrate, not shown). The X-ray shielding sections 42a are arranged on an X-ray transmitting substrate (for example, a glass substrate, not shown). The first and second absorption gratings 41 and 42 do not provide phase difference to the incident X-rays. Instead, the first and second absorption gratings 41 and 42 provide intensity difference to the incident X-rays. This is why the first and second absorption gratings 41 and 42 are also referred to as amplitude gratings. Slit portions (the spaces d₁ and d₂, for example) may not be formed as openings. The slit portions may be filled with a material with low X-ray absorption, for example, polymer or light metal.

The first and second absorption gratings 41 and 42 are configured to linearly project the X-rays passed through their slit portions. To be more specific, each of the spaces d₁ and d₂ is made sufficiently larger than a peak wavelength of the X-rays emitted from the X-ray source 11 so that most of the X-rays pass through the slit portions linearly without diffraction. For example, when the rotating anode 21 of the X-ray tube 20 is made of tungsten, and the tube voltage is 50 kV, the peak wavelength of the X-rays is approximately 0.4 Å. To linearly project most of the X-rays without causing diffraction at the slit portions, each of the spaces d₁ and d₂ is of the order of 1 μm to 10 μm. Each of the pitches p₁ and p₂ is of the order of 2 μm to 20 μm.

The X-ray source 11 emits the X-rays not in parallel beams but in cone beams from an X-ray focal point being an emission point. Accordingly, a first periodic pattern image (hereinafter referred to as G1 image) projected or formed by the X-rays passed through the first absorption grating 41 is enlarged in proportion to the distance from linear light sources 11a to 11c. The grating pitch p₂ and the space d₂ of the second absorption grating 42 are determined such that the slit portions of the second absorption grating 42 substantially coincide with a periodic pattern of bright areas of the G1 image formed at the position of the second absorption grating 42. When L₁ denotes a distance between the linear light sources 11a to 11c and the first absorption grating 41 and L₂ denotes a distance between the first absorption grating 41 and the second absorption grating 42, the grating pitch p₂ and the space d₂ are determined to satisfy mathematical expressions (1) and (2).

$$\begin{matrix}{p}_{2} = \frac{{L}_{1} + {L}_{2}}{{L}_{1}} {p}_{1} & ( 1 ) \\ {d}_{2} = \frac{{L}_{1} + {L}_{2}}{{L}_{1}} {d}_{1} & ( 2 )\end{matrix}$$

In the Talbot interferometer, the distance L₂ between the first absorption grating 41 and the second absorption grating 42 is restricted by Talbot length that is defined by the grating pitch of the first absorption grating and the X-ray wavelength. In the imaging unit 12 of this embodiment, on the other hand, the first absorption grating 41 projects the incident X-rays without diffraction. An image proportional to the G1 image of the first absorption grating 41 is obtained at any position behind the first absorption grating 41. As a result, the distance L₂ can be set independently of the Talbot length.

The pitch p₃ of the linear light sources 11a to 11c is set to satisfy an expression (3).

$${p}_{3} = \frac{{L}_{1}}{{L}_{2}} {p}_{2} \qquad ( 3 )$$

The expression (3) shows a geometric condition to superpose the G1 images, formed by the X-rays emitted from the linear light sources 11a to 11c and passed through the first absorption grating 41, onto the second absorption grating 42. In this embodiment, the G1 images, formed based on the respective linear light sources 11a to 11c, are superposed to improve the X-ray intensity.

Next, an operation of the above embodiment is described. As shown in FIG. 1, in the X-ray imaging system 10, an object H is arranged between the X-ray source 11 and the imaging unit 12. In this state, when an image capture command is inputted to the system controller 18 from the console 17, the imaging controller 16 controls components of the X-ray imaging system 10 to move the second absorption grating 42 at a predetermined pitch in the X direction relative to the first absorption grating 41. Thereby, the relative position of the second absorption grating 42 is changed step-by-step relative to the first absorption grating 41. At each of the relative positions, the X-ray source 11 emits the X-rays and the FPD 40 performs the detection of the X-rays.

As shown in FIGS. 2A and 2B, in the X-ray tube 20, the cathode 22 emits the electron beams B to the inclined surface 24 of the anode plate 25 when the second absorption grating 42 is positioned at each of the relative positions. The emission of the electron beams B from the cathode 22 causes the anode plate 25 to generate X-rays. The X-rays generated from the anode plate 25 pass through the X-ray passing portion 32 and the radiation window 33 of the case 23 and then are radiated to the outside of the case 23. When passing through the X-ray passing portion 32 and the radiation window 33, the X-rays are partly shielded by the X-ray shielding sections 36 of the multi-slit 35. Thereby, the virtual linear light sources 11a to 11c are formed. The linear light sources 11a to 11c are arranged in the X direction at the predetermined pitch. Each of the linear light sources 11a to 11c has the reduced effective focal size in the X direction.

The phase difference occurs when the X-rays from the linear light sources 11a to 11c traverse the object H. The X-rays then pass through the first absorption grating 41 to form the G1 images. Each G1 image carries transmission phase information of the object H. The transmission phase information is determined by a refractive index of the object H and a transmission optical path. The G1 images formed by the X-rays emitted from the respective linear light sources 11a to 11c are projected, and superposed to and coincide with the second absorption grating 42.

The intensity of the G1 images superposed are modulated by the second absorption grating 42, to form a second periodic pattern image (G2 image). The FPD 40 detects the G2 image formed at each of the above-described relative positions. The image processor 14 generates the differential phase image (corresponding to the angular distribution of the X-rays refracted by the object) from a phase shift value of the pixel data of each pixel in the FPD 40. The phase shift value is a value of the phase shift between the presence and absence of the object H. The image processor 14 integrates the differential phase image in the X direction. Thereby, the phase contrast image of the object H is obtained. The phase contrast image is stored in the image storage 15. The phase contrast image is displayed on the monitor of the console 17, for example.

As described above, in the X-ray tube 20 of this embodiment, the multi-slit 35 is provided in the radiation window 33. Thereby, the distance between the X-ray focal point and the multi-slit 35 is shorter than that of the conventional imaging system where the multi-slit is arranged outside of the X-ray source. This reduces a noncoherent component and a scatter component of the X-rays. As a result, image quality of the phase contrast image is improved. Because the multi-slit is arranged outside the vacuum envelope 28, the cost and the size of the X-ray tube 20 remain similar to those of the conventional X-ray tube.

Hereinafter, other embodiments of the present invention are described. Like numerals refer to like elements throughout, and the descriptions thereof are omitted.

### Second Embodiment

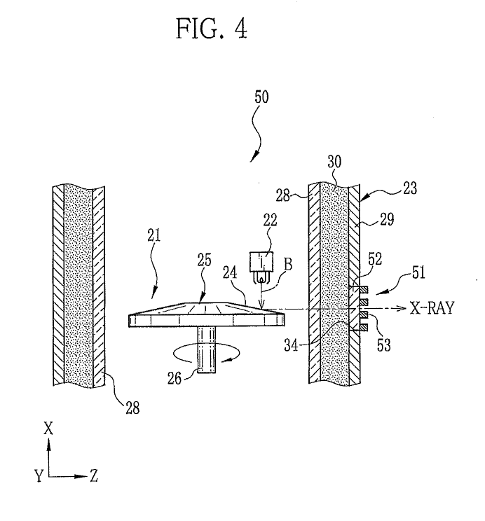

Like an X-ray tube 50 shown in FIG. 4, a radiation window 51 of the housing 29 may be composed of the opening 34 and an X-ray transmitting member 52 filled or fixed inside the opening 34, in a manner similar to the conventional X-ray tube. A multi-slit pattern 53 may be formed on one of inner and outer surfaces of the X-ray transmitting member 52. The multi-slit pattern 53 is made from a material with high X-ray absorption property, for example, gold, platinum, silver, lead, or tungsten. According to this configuration, a change or improvement is made to the conventional X-ray tube to achieve the effects similar to or the same as those of the X-ray tube 20 in the first embodiment.

### Third Embodiment

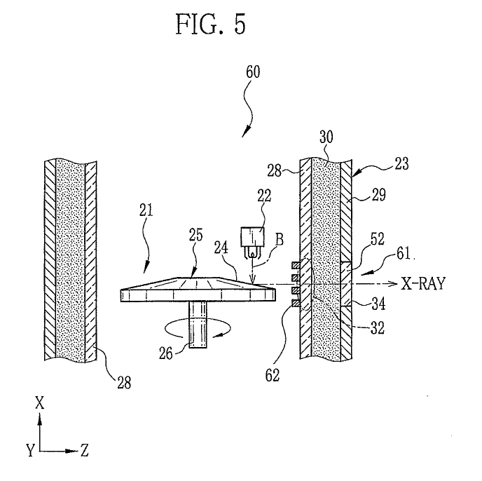

Like an X-ray tube 60 shown in FIG. 5, a radiation window 61 of the housing 29 may be composed of the opening 34 and the X-ray transmitting member 52. A multi-slit pattern 62 may be formed on an inner surface of the X-ray passing portion 32 of the vacuum envelope 28. The multi-slit pattern 62 is made from a material with high X-ray absorption property, for example, gold, platinum, silver, lead, or tungsten. Thereby, the distance between the X-ray focal point and the multi-slit pattern 62 is more reduced than those in the first and second embodiments. When the X-rays pass through the insulating oil 30, x-ray scattering is likely to occur. In this embodiment, the X-ray source is made into a plurality of the linear light sources before the X-rays pass through the insulating oil 30. As a result, scatter components of the X-rays are reduced. Alternatively, the multi-slit pattern 62 may be provided to an outer surface of the X-ray passing portion 32 of the vacuum envelope 28.

In the above embodiments, the X-ray imaging apparatus using the stripe-like one-dimensional grating is described by way of example. This one-dimensional grating has a plurality of the X-ray shielding sections extending in one direction and arranged in a direction orthogonal to the extending direction. The present invention can be applied to an X-ray imaging apparatus using a two-dimensional grating in which the X-ray shielding sections are arranged in two directions. In the above embodiments, the object H is arranged between the X-ray source and the first absorption grating. The phase contrast image can also be generated in the same or similar manner when the object H is arranged between the first absorption grating and the second absorption grating. The above embodiments can be combined as long as the combination does not contradict the scope of the present invention.

In the above embodiments, the first and second absorption gratings are configured to linearly project the X-rays passed through their slit portions. The present invention is not limited to the above configuration. The first absorption grating may diffract the X-rays to cause the so-called Talbot effect (see U.S. Patent Application Publication No. 2005/0286680 corresponding to WO 2004/058070). In this case, a distance between the first and second absorption gratings is set to the Talbot distance. Alternatively, a phase grating with a relatively low aspect ratio may be used as the first absorption grating.

In the above embodiments, the fringe image is subjected to the intensity modulation by the second absorption grating, and then is detected using the fringe scanning method to generate the phase contrast image. Alternatively, an X-ray imaging system for generating a phase contrast image by a single image capture is disclosed in U.S. Patent Application Publication No. 2011/0158493 corresponding to WO 2010/050483, for example. In this X-ray imaging system, an X-ray image detector detects a moiré pattern generated by first and second gratings. Intensity distribution of the moiré pattern is subjected to Fourier transform to obtain a spatial frequency spectrum. A spectrum corresponding to a carrier frequency is separated from the spatial frequency spectrum, and inverse Fourier transform is performed. Thereby, a differential phase image is obtained. The X-ray tube of the present invention can also be applied to this X-ray imaging system.

Out of the X-ray imaging systems for generating the phase contrast image by the single image capture, there is an X-ray imaging system using a direct-conversion type X-ray image detector as the intensity modulator instead of the second grating (see U.S. Patent Application Publication No. 2009/0110144 corresponding to Japanese Patent Laid-Open Publication No. 2009-133823, for example). The direct-conversion type X-ray image detector is provided with a conversion layer and a charge-collection electrode. The conversion layer converts the X-rays into electric charge. The charge-collection electrode collects the electric charge generated by the conversion layer. The charge-collection electrode in each pixel is composed of linear electrode groups arranged to have mutually different phases. Each linear electrode group is composed of linear electrodes arranged at a predetermined period and electrically connected to each other. The predetermined period substantially coincides with a periodic pattern of a fringe image formed by the first grating. Each linear electrode group is controlled individually to collect the electric charge. Thereby, fringe images are obtained by the single image capture. The phase contrast image is generated based on the fringe images. The X-ray tube of the present invention can also be applied to this X-ray imaging system.

There is another type of X-ray imaging system capable of generating a phase contrast image by the single image capture. In this X-ray imaging system, each of the first and second gratings is arranged such that extending directions of the gratings are tilted by a predetermined angle relative to each other. The moiré period in the extending direction caused by the tilt is divided into segments and an image is captured. Thereby, fringe images are obtained at different relative positions between the first and second gratings. A phase contrast image can be generated from the fringe images. The X-ray tube of the present invention can also be applied to this X-ray imaging system.

There is another type of X-ray imaging system which uses an optical read-out type X-ray image detector as an intensity modulator to eliminate the use of the second grating. In this system, a first electrode layer, a photoconductive layer, a charge accumulation layer, and a second electrode layer are layered in this order. The first electrode layer transmits a first periodic pattern image formed by a first grating. The photoconductive layer detects the first periodic pattern image, transmitted through the first electrode layer, to generate electric charge. The charge accumulation layer accumulates the electric charge. The second electrode layer is provided with a plurality of linear electrodes that transmit read-out light. The linear electrodes correspond to respective pixels. An image signal is read out on a pixel-by-pixel basis by scanning using the read-out light. The charge accumulation layer is formed into a grating with a pitch smaller than an arrangement pitch of the linear electrodes. Thereby, the charge accumulation layer functions as the second grating. The X-ray tube of the present invention can also be applied to this X-ray imaging system.

The above embodiments can be applied to radiation imaging systems for medical diagnosing, industrial use, and non-destructive examination, for example. In the present invention, radiation other than the X-rays, for example, gamma rays can be used.

Various changes and modifications are possible in the present invention and may be understood to be within the present invention.

What is claimed is:

1. A radiation tube comprising:
a cathode for emitting electron beams;
an anode for generating radiation due to emission of the electron beams from the cathode;
a case for enclosing the cathode and the anode, the case including a radiating portion for radiating the radiation to outside of the case; and
a multi-slit provided to the radiating portion, the multi-slit partly shielding the radiation to form a plurality of linear light sources.

2. The radiation tube of claim 1, wherein the case has a vacuum envelope and a housing, and the vacuum envelope encloses the cathode and the anode, and the housing encloses the vacuum envelope, and the radiating portion includes an opening formed through the housing.

3. The radiation tube of claim 2, wherein the multi-slit is fixed to the housing so as to cover the opening.

4. The radiation tube of claim 2, wherein the multi-slit includes a radiation-transmitting member filled in the opening and a multi-slit pattern provided to the radiation-transmitting member.

5. The radiation tube of claim 1, wherein the case has a vacuum envelope and a housing, and the vacuum envelope encloses the cathode and the anode, and the housing encloses the vacuum envelope, and the radiating portion includes a radiation passing portion provided to the vacuum envelope, and the radiation passing portion allows the radiation to pass therethrough, and the multi-slit includes a multi-slit pattern provided to the radiation passing portion.

6. A radiation imaging system comprising:
a first grating for passing radiation from a radiation source to form a first periodic pattern image, the first grating having transmission portions for transmitting the radiation and absorption portions for absorbing the radiation, the transmission portions and the absorption portions being arranged periodically to form a grating structure;
an intensity modulator for providing intensity modulation to the first periodic pattern image in at least one of relative positions out of phase with the first periodic pattern image;
a radiation image detector for detecting a second periodic pattern image, the second periodic pattern image being generated in the relative position by the intensity modulator;
a processor for producing an image representing phase information based on the at least one second periodic pattern image detected by the radiation image detector;
wherein a radiation tube is used as the radiation source, and the radiation tube includes a cathode for emitting electron beams, an anode for generating the radiation due to emission of the electron beams from the cathode, a case for enclosing the cathode and the anode, and a multi-slit, and the case includes a radiating portion for radiating the radiation to outside of the case, and the multi-slit is provided to the radiating portion, and the multi-slit partly shields the radiation to form a plurality of linear light sources.

7. The radiation imaging system of claim 6, wherein the intensity modulator includes a second grating and a scan section, and the second grating has transmission portions for transmitting the first periodic pattern image and absorption portions for absorbing the first periodic pattern image, and the transmission portions and the absorption portions are arranged periodically to form a grating structure, and the scan section moves one of the first and second gratings to positions at a predetermined pitch in a direction of periodicity of the grating structures of the first and second gratings, and the positions correspond to the respective relative positions.
